(19) United States
(12) Patent Application Publication
(10) Pub. No.: US 2016/0096351 A1
(43) Pub. Date: Apr. 7, 2016

(54) DUAL COATED FILM FOR BONDING DISSIMILAR MATERIALS

(71) Applicants: Raymond Augustus McDonald, JR., Pooler, GA (US); Gary Alan Grandominico, Galena, OH (US); Dominic Plauche Grandominico, Columbus, OH (US); Kyle Timothy Gaines, Blacklick, OH (US); Greg Anthony Karst, Columbus, OH (US)

(72) Inventors: Raymond Augustus McDonald, JR., Pooler, GA (US); Gary Alan Grandominico, Galena, OH (US); Dominic Plauche Grandominico, Columbus, OH (US); Kyle Timothy Gaines, Blacklick, OH (US); Greg Anthony Karst, Columbus, OH (US)

(73) Assignee: RIDGE CORPORATION, Pataskala, OH (US)

(21) Appl. No.: 14/873,910

(22) Filed: Oct. 2, 2015

Related U.S. Application Data
(60) Provisional application No. 62/059,062, filed on Oct. 2, 2014.

(51) Int. Cl. B32B 37/12; B32B 37/14

(52) U.S. Cl. CPC B32B 37/12; B32B 37/14; B32B 2323/10; B32B 2317/16; B32B 2311/30; B32B 2311/24; B32B 2375/00

(57) ABSTRACT

The innovation disclosed herein comprises an apparatus and method of bonding two dissimilar materials together using a chemically treated bondable film that is chemically treated (coated) on at least one side to facilitate adhesion between the two dissimilar materials.

### CROSS-REFERENCE TO RELATED APPLICATIONS

This application claims the benefit of U.S. Provisional Patent application Ser. No. 62/059,062 entitled “DUAL COATED FILM FOR BONDING DISSIMILAR MATERIALS” filed on Oct. 2, 2014. The entirety of the above-noted application is incorporated herein by reference.

### BACKGROUND

It is well known that challenges exist in bonding dissimilar materials together for a structural bond. These challenges are caused at least by variances in surface energy, texture, or environment. A particular challenge exists when dealing with thermoplastic polymers such as polypropylene. In the past, secondary processes such a corona treatment, flame treatment, or chemical primers have been used to help promote chemical adhesion when polypropylene was one of the adherents. These processes require secondary handing of the sub-straights and require costly equipment. Additionally, these conventional processes are also difficult to control and most often produce varying levels of adhesion (or failure) over time as the surface treatments degrade.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect an apparatus for bonding two dissimilar materials is disclosed and includes a bonding composition including: a film having a first side and a second side; and a first chemical treatment applied to at least one of the first and second sides of the film and having first chemical properties, wherein a first material having first material properties is bonded to the first side of the film and a second material having second material properties is bonded to the second side of the film, wherein the first material properties are dissimilar than the second material properties, and wherein the first chemical properties are compatible with one of the first material and second material.

In another aspect of the innovation, a second chemical treatment having second chemical properties that are dissimilar to the first chemical properties applied to an opposite side of the film as the first chemical treatment, wherein the second chemical properties are compatible with the other one of the first material and second material is disclosed. In still yet another aspect of the innovation, A method of bonding two dissimilar materials together is disclosed and includes providing a first material having first material properties; providing a second material having second material properties that are dissimilar than the first material properties; providing a film disposed between the first material and the second material; treating at least one side of the film with a chemical treatment having first chemical properties that facilitates adhesion of the first side of the film to the first material; bonding the first side of the film to the first material; and bonding the second side of the film to the second material.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is an example embodiment illustrating an apparatus and process of bonding two dissimilar materials together in accordance with an aspect of the innovation.

FIG. 2 is a block diagram illustration of a method of adhering two dissimilar materials together in accordance with an aspect of the innovation.

### DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

The innovation disclosed and claimed herein comprises an apparatus and process of bonding two dissimilar materials together using a chemically treated bondable film that is chemically treated (coated) on at least one side to facilitate adhesion between the two dissimilar materials. The innovation uses a chemically treated film (e.g., tie film), such as but not limited to a polyethylene terephthalate (PET) film, as a “structural link” between the two dissimilar materials that could not be bonded together chemically using conventional methods. The chemical treatment (or coating) acts as an “adhesion promoter” that facilitates the adhesion between the two dissimilar materials or adhesives. The film is chemically treated via a lamination method that enables the film to be pre-laminated to either the first or second material, which facilitates the ability to cut or pre-manufacture the first and/or the second material in a fashion that is easily used in secondary operations, such as but not limited to, the application to a wood floor board. In addition, the chemical treatment(s) can be applied to the film during the manufacture of the film, which provides a significant cost savings versus post manufacturing applied primers in other technologies.

The innovative apparatus and method can be applied to a wide variety of materials and adhesives. For example, the innovation facilitates the bonding of a first material, such as but not limited to, thermoplastics (e.g., olefin composites, such as but not limited to polypropylene) to a second material (non-thermoplastic), such as but not limited to, wood, steel, plastics, polyurethane, etc.

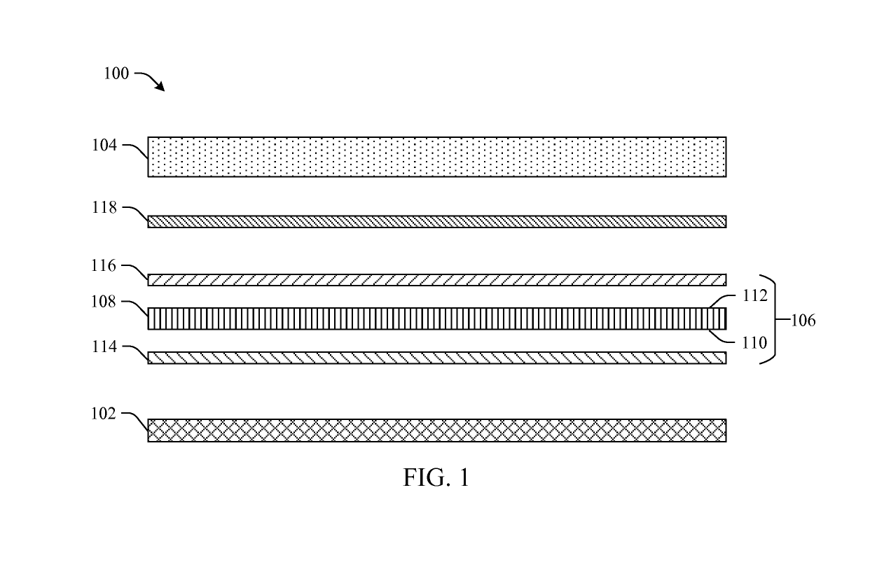

Referring now to the drawings, FIG. 1 is an example embodiment illustrating an apparatus 100 and process of bonding two dissimilar materials together in accordance with an aspect of the innovation. In the illustrated example, a first material 102 is provided and is comprised of first material properties. The first material 102 may be comprised of a thermoplastic, such as but not limited to, an olefin composite material, such as but not limited to, polypropylene. A second material (substrate) 104 is provided and is comprised of second material properties that are dissimilar to the first material properties. It is to be understood that the term “dissimilar” is used herein to define that two or more materials have a different molecular and/or chemical composition and thus, have different adhering properties. The second material 104 may be comprised of a material that has different adhering properties (e.g., a non-thermoplastic material) as the first material 102, such as but not limited to, wood, steel, aluminum, aggregate materials (e.g., concrete, asphalt, etc.), etc. or to another thermoplastic material, such as but not limited to polyethylene, polyurethane, etc.

Still referring to FIG. 1, an innovative bonding apparatus 106 is provided between the first and second materials 102, 104 that facilitates an adhesion of the two dissimilar materials 102, 104. The bonding apparatus 106 includes a film 108 having a first side 110 and a second side 112. A first chemical treatment (or coating) 114 may be applied to the first side 110 of the film 108 and a second chemical treatment (or coating) 116 may be applied to the second side 112 of the film 108. The chemical treatment or treatments 114, 116 can be modified to promote higher adhesion strengths at higher application temperatures. Although, chemical treatments are shown in FIG. 1 as being applied to both sides of the film 108, it is to be understood that the chemical treatments may be applied to only one side (either side) or may be applied to both sides of the film layer 108. It is to be further understood that the first chemical treatment can be applied to either side of the film and similarly, the second chemical treatment can be applied to either side of the film. Thus, the example embodiment illustrated in FIG. 1 is for illustrative purposes only and is not intended to limit the scope of the innovation.

The film 108 may be comprised of a polymer resin, such as but not limited to polyethylene terephthalate (PET) or foil. The film 108 can have a thickness (e.g., 0.5-5.0 mils) that can be varied to match the structural requirements first and second materials 102, 104 and of an adhesive described further below. In addition, the film 108 can include other features, such as but not limited to, properties that prevent ultraviolet (UV) degradation, prevention of moisture penetration, the film 108 can be colored, etc.

The first chemical treatment 114 applied to the first side 110 of the film 108 has a first chemical property that facilitates an adhesion to the first material 102. In other words, the first chemical property of the first chemical treatment 114 has adhesion properties that are compatible with adhesion properties of the first material 102. It is to be understood that the term “compatible” is used herein to define that two or more chemical properties of chemical treatments, materials, adhesive, etc. have similar adhering properties and thus, form a bond upon undergoing a bonding process. As such, through a bonding or adhesion process (e.g., heating), the first chemical treatment 114 facilitates a strong bond between the first side 110 of the film 108 and the first material 102.

The second chemical treatment 116 applied to the second side 112 of the film 108 has a second chemical property that facilitates an adhesion to the second material 104. A second material adhesive (hereinafter “adhesive”) 118, however, is disposed between the second material 104 and the second side 112 of the film 108. The adhesive 118 has chemical properties that are compatible with the properties of the second material properties of the second 104 and also compatible with the chemical properties of the second chemical treatment 116. As such, through a bonding or adhesion process (e.g., heating), the second chemical treatment 116 facilitates a strong bond with the adhesive 118 and thus, between the second side 112 of the film 108 and the adhesive 118. In addition, the adhesive 118 forms a strong bond with the second material 104. As a result, the bonds between the second chemical treatment 116 and the adhesive 118, and between the adhesive 118 and the second material 104 form a strong bond between the second material 104 and the film 108. The second chemical treatment 116 can be modified to bond with a wide array of adhesives 118, such as but not limited to polyurethanes, acrylics, epoxies, elastomers, etc.

Once the film 108 has been chemically treated on one or both of the first and second sides 110, 112, the film 108 can be applied to the first material (e.g., thermoplastic substrate) 102 in a continuous lamination process where the first material 102 is heated past its transition temperature and chemically adheres to the first chemical treatment 114 on the film 108. The end product yields a first material 102 (e.g., thermoplastic substrate) that has an exposed side that has been chemically treated to structurally adhere to another adhesive, as described herein.

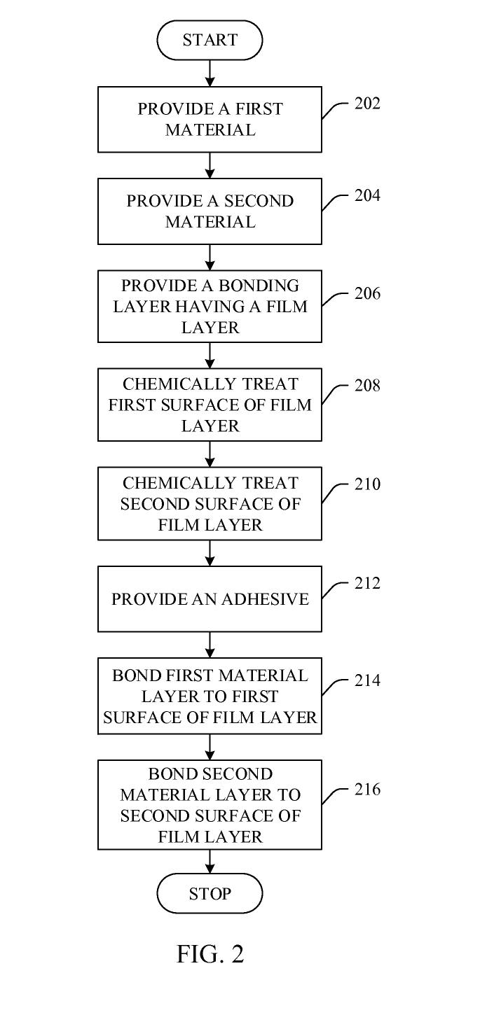

With reference still to FIG. 1 and the above description, FIG. 2 is a block diagram illustration of a method of adhering the two dissimilar materials in accordance with an aspect of the innovation. Although, the method described herein describes applying a chemical coating to both sides of the film 108, it is to be understood that the chemical treatment may be applied to only one side (either side). At 202, a first material 102 having first material properties is provided. At 204, a second material 104 having second material properties that are dissimilar than the first material properties is provided. At 206, the bonding apparatus 106 that includes the film 108 disposed between the first and second materials 102, 104 is provided. At 208, the first side 110 of the film 108 is chemically treated with the first chemical treatment 114. At 210, the second side 112 of the film 108 is chemically treated with the second chemical treatment 116. At 212, the adhesive 118 is provided and disposed between the film and the second material 104. At 214, the first material 102 is adhered or bonded to the first side 110 of the film 108 via a bonding or adhesion process. At 216, the second material 104 is adhered or bonded to the second side 112 of the film 108 via a bonding or adhesion process.

An example of the innovation would be the bonding of polyurethane to polypropylene. Without using a primer, a mechanical adhesion promoter (scrim), or other surface treatment, the adhesion between polyurethane and polypropylene is very weak and may degrade over time. On the other hand, the innovation and technology as described herein, employs a film that is chemically treated on one or both sides to achieve much higher bond strengths and provide a structural attachment between the two materials.

The innovation disclosed herein has many other applications, such as but not limited to, the transportation industry and more specifically, for use on cargo transportation vehicles (e.g., long-haul trailers, refrigerated trailers, etc.). For example, many long-haul trailers use components that are bonded together with polyurethane adhesives or sealants. Some areas of particular interest may include: 1) wood composite flooring, 2) refrigerated trailer walls, and 3) roof bow to roof sheet assembly, 4) dry freight sidewall liners to side posts, and 5) exterior wall skins to a core or wall post.

In regards to the composite wood flooring, the composite floor marries together a fiber reinforced composite sheet with wood to produce a structural glue-lam that allows for higher floor strengths and reduced trailer weight. The flooring industry currently relies upon thermoset materials such as epoxy in the composite sheet in order to achieve adhesion when using a reactive hot-melt polyurethane resin. This combination of materials and processes are expensive, non-recyclable, and limited in supply. The innovative chemically treated film 108 disclosed herein, on the other hand, ca be used with the thermoplastic material that is produced from a less-expensive resin (e.g., olefin resins, such as but not limited to polypropylene) and is available in vast quantities. Thus, as an example, the first material 102 includes the thermoplastic material and the second material 104 includes a wood material. The film 108 can be chemically treated with appropriate treatments to facilitate the adhesion of the thermoplastic material 102 to the wood material 104 as described herein.

Another example application of the innovation can be appreciated in the adhesion of (and to) polyurethane (PU) foam in refrigerated trailers. Thermoplastic composites have transformed this type of construction in long haul trailers. Conventional approaches, however, use a mechanical adhesion to hold the wall structure together. The mechanical bond is achieved by using a scrim (e.g., lining), which creates a rough surface for the PU foam to adhere to. The mechanical bond, however, can be replaced using a thermoplastic (first) material 102 as the wall liner and bonding the polyurethane foam (second material) 104 with the innovative chemically treated film 108, as described herein, resulting in a stronger chemical bond and a stronger finished product. Thus, the innovation can eliminate the use of the scrim and provide a bondable surface on the back side of the wall liner capable of adequate adhesion to the PU foam. It is to be understood that this same process could be used on dry-freight trailers to provide a bondable chemically treated surface to adhere to coated steel uprights or core material.

To further illustrate examples of the innovation, a third example is provided for use on a translucent roof sheet. The translucent roof sheet could be laminated with the chemically treated film with an exposed side treated in such a way as to promote adhesion to coated steel or aluminum roof bows. Traditionally, manufacturer's use a polyurethane sealant or a polysulfide adhesive to make the attachment. In accordance with the innovation, the film treatment would be chemically altered to promote superior adhesion to whichever sealant would be used.

Another example application is in the bridge and building industries that use aggregate materials (e.g., concrete, asphalt, etc.) for columns and supports. The innovation could be used to wrap the columns to facilitate controlling compression.

It is to be understood that the innovative chemically treated film can be used in any industry where two dissimilar materials are to be bonded together. For example, the first material can be a thermoplastic material, such as but not limited to, polypropylene. The second material may be comprised of a material that has different adhering properties (e.g., a non-thermoplastic material) as the first material, such as but not limited to, wood, steel, aluminum, aggregate materials (e.g., concrete, asphalt, etc.), etc.

It is further to be understood that the innovative chemically treated film can be used in any industry where two similar materials are to be bonded together. For example, the first material can be a thermoplastic material, such as but not limited to, polypropylene. The second material may also be comprised of a thermoplastic material, such as but not limited to, polyethylene, polyurethane, etc. Thus, although the innovation described references dissimilar materials, it is to be understood that the innovation can be applied to the bonding of two similar materials.

The above identified aspects are indicative, however, of but a few of the various ways in which the principles of the innovation can be employed and the subject innovation is intended to include all such aspects and their equivalents. Additionally, while specific long-haul truck examples are described, it is to be understood that the innovation can be employed in other industries and applications as advantageous—all of which are to be included within the scope of this description and claims appended hereto. Other advantages and novel features of the innovation will become apparent from the following detailed description of the innovation when considered in conjunction with the drawings.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for bonding two dissimilar materials comprising:
a bonding composition including:
a film having a first side and a second side; and
a first chemical treatment applied to at least one of the first and second sides of the film and having first chemical properties,
wherein a first material having first material properties is bonded to the first side of the film and a second material having second material properties is bonded to the second side of the film, wherein the first material properties are dissimilar than the second material properties, and
wherein the first chemical properties are compatible with one of the first material and second material.

2. The apparatus of claim 1 further comprising a second chemical treatment having second chemical properties that are dissimilar to the first chemical properties applied to an opposite side of the film as the first chemical treatment, wherein the second chemical properties are compatible with the other one of the first material and second material.

3. The apparatus of claim 2 further comprising an adhesive disposed between the second material and the second side of the film, wherein the adhesive has chemical properties that are compatible with the second material properties of the second material to thereby bond to the second material and that are compatible with the second chemical properties of the second chemical treatment applied to the opposite side of the film thereby forming a bond to the second side of the film.

4. The apparatus of claim 3, wherein the first material is a thermoplastic material and the second material is a non-thermoplastic material.

5. The apparatus of claim 4, wherein the thermoplastic material is polypropylene and the non-thermoplastic material is one of a wood material, steel, aluminum, and polyurethane.

6. A method of bonding two dissimilar materials together comprising:
providing a first material having first material properties;
providing a second material having second material properties that are dissimilar than the first material properties;
providing a film disposed between the first material and the second material;
treating at least one side of the film with a chemical treatment having first chemical properties that facilitates adhesion of the first side of the film to the first material;
bonding the first side of the film to the first material; and
bonding the second side of the film to the second material.

7. The method of claim 6, wherein prior to bonding the first side of the film to the first material the method further comprising treating an opposite side of the film with a chemical treatment having second chemical properties that are dissimilar from the first chemical properties.

8. The method of claim 7, wherein prior to bonding the first side of the film to the first material the method further comprising providing an adhesive disposed between the second material and the second side of the film, wherein the adhesive has chemical properties that are compatible with the second material properties of the second material and with the second chemical properties of the chemical treatment applied to the opposite side of the film thereby forming a bond between the second material and the second side of the film.

9. The method of claim 8, wherein the first material is a thermoplastic material and the second material is a non-thermoplastic material.

10. The method of claim 9, wherein the thermoplastic material is a olefin resin composite.

11. The method of claim 10, wherein the olefin resin composite is polypropylene.

12. The method of claim 9 wherein the second material is a non-composite material.

13. The method of claim 12, wherein the non-composite material is one of a wood material, steel, aluminum, and polyurethane.

14. The method of claim 8, wherein the film is a polymer resin.

15. The method of claim 14, wherein the polymer resin is polyethylene terephthalate.

16. The method of claim 8, wherein the adhesive is one of polyurethanes, acrylics, epoxies, and elastomers.

17. A method of bonding two dissimilar materials together comprising:
providing a first material having first material properties;
providing a second material having second material properties that are dissimilar than the first material properties;
providing a film disposed between the first material and the second material;
treating a first side of the film with a first chemical treatment having first chemical properties that facilitates adhesion of the first side of the film to the first material;
treating a second side of the film with a second chemical treatment having second chemical properties that are dissimilar from the first chemical properties and that facilitates an adhesion of the second side of the film layer to the second material;
bonding the first side of the film to the first material; and
bonding the second side of the film to the second material.

18. The method of claim 17, wherein prior to bonding the first side of the film to the first material the method further comprising providing an adhesive disposed between the second material and the second side of the film, wherein the adhesive has chemical properties that are compatible with the second material properties of the second material and with the second chemical properties of the chemical treatment applied to the second side of the film thereby forming a bond between the second material and the second side of the film.

19. The method of claim 18, wherein the first material is a thermoplastic material and the second material is a non-thermoplastic material.

20. The method of claim 19, wherein the thermoplastic material is polypropylene and the non-thermoplastic material is one of a wood material, steel, aluminum, and polyurethane.
